(19) United States
(12) Patent Application Publication
(10) Pub. No.: US 2026/0116665 A1
(43) Pub. Date: Apr. 30, 2026

(54) STORAGE SYSTEM

(71) Applicant: Ocado Innovation Limited, Hatfield (GB)

(72) Inventor: David SOBEY, London (GB)

(21) Appl. No.: 19/118,307

(22) PCT Filed: Oct. 19, 2023
(86) PCT No.: PCT/EP2023/079177

§ 371 Date: Apr. 3, 2025

(30) Foreign Application Priority Data
Oct. 20, 2022 (GB) 2215506.3

(51) Int. Cl. B65G 1/137; B65G 1/04

(52) U.S. Cl. CPC B65G 1/1375; B65G 1/0478

(57) ABSTRACT

A grid-based automated storage and retrieval system in which a mezzanine level is present beneath the top level of the grid. Containers may be lowered to and subsequently retrieved from the mezzanine level from bots operating on the grid. A robotic arm is located such that it can access the interior of containers received on the mezzanine level and can transfer an item from a first container to a second container.

### TECHNICAL FIELD

The present disclosure relates generally to the field of automated storage and retrieval systems for use in warehouses and/or fulfilment centres and more specifically to an automated storage and retrieval system which comprises a robotic picking arm.

### BACKGROUND

Online retail businesses selling multiple product lines, such as online grocers and supermarkets, require systems that are able to store tens or even hundreds of thousands of different product lines. The use of single-product stacks in such cases can be impractical, since a very large floor area would be required to accommodate all of the stacks required. Furthermore, it can be desirable only to store small quantities of some items, such as perishables or infrequently-ordered goods, making single-product stacks an inefficient solution.

International patent application WO 98/049075A (Autostore), the contents of which are incorporated herein by reference, describes a system in which multi-product stacks of containers are arranged within a frame structure.

PCT Publication No. WO2015/185628A (Ocado) describes a further known storage and fulfilment system in which stacks of bins or containers are arranged within a framework structure. The bins or containers are accessed by load handling devices operative on tracks located on the top of the frame structure. The load handling devices lift bins or containers out from the stacks, multiple load handling devices co-operating to access bins or containers located in the lowest positions of the stack. A system of this type is illustrated schematically in FIGS. 1 to 4 of the accompanying drawings.

FIG. 1 illustrates an automated storage and retrieval structure 1 comprising upright members 3 and horizontal members 5, 7 which are supported by the upright members 3. The horizontal members 5 extend parallel to one another and the illustrated x-axis. The horizontal members 7 extend parallel to one another and the illustrated y-axis, and transversely to the horizontal members 5. The upright members 3 extend parallel to one another and the illustrated z-axis, and transversely to the horizontal members 5, 7. The horizontal members 5, 7 form a grid pattern defining a plurality of grid cells. In the illustrated example, containers 9 are arranged in stacks 11 beneath the grid cells defined by the grid pattern, one stack 11 of containers 9 per grid cell.

FIG. 2 shows a large-scale plan view of a section of track structure 13 forming part of the storage structure 1 illustrated in FIG. 1 and located on top of the horizontal members 5, 7 of the storage structure 1 illustrated in FIG. 1. The track structure 13 may be provided by the horizontal members 5, 7 themselves (e.g. formed in or on the surfaces of the horizontal members 5, 7) or by one or more additional components mounted on top of the horizontal members 5, 7. The illustrated track structure 13 comprises x-direction tracks 17 and y-direction tracks 19, i.e. a first set of tracks 17 which extend in the x-direction and a second set of tracks 19 which extend in the y-direction, transverse to the tracks 17 in the first set of tracks 17. The tracks 17, 19 define apertures 15 at the centres of the grid cells. The apertures 15 are sized to allow containers 9 located beneath the grid cells to be lifted and lowered through the apertures 15. The x-direction tracks 17 are provided in pairs separated by channels 21, and the y-direction tracks 19 are provided in pairs separated by channels 23. Other arrangements of track structure may also be possible.

FIG. 3 shows a plurality of load-handling devices 31 moving on top of the storage structure 1 illustrated in FIG. 1. The load-handling devices 31, which may also be referred to as robots 31 or bots 31, are provided with sets of wheels to engage with corresponding x- or y-direction tracks 17, 19 to enable the bots 31 to travel across the track structure 13 and reach specific grid cells. The illustrated pairs of tracks 17, 19 separated by channels 21, 23 allow bots 31 to occupy (or pass one another on) neighbouring grid cells without colliding with one another.

As illustrated in detail in FIG. 4, a bot 31 comprises a body 33 in or on which are mounted one or more components which enable the bot 31 to perform its intended functions. These functions may include moving across the storage structure 1 on the track structure 13 and raising or lowering containers 9 (e.g. from or to stacks 11) so that the bot 31 can retrieve or deposit containers 9 in specific locations defined by the grid pattern.

The illustrated bot 31 comprises first and second sets of wheels 35, 37 which are mounted on the body 33 of the bot 31 and enable the bot 31 to move in the x- and y-directions along the tracks 17 and 19, respectively. In particular, two wheels 35 are provided on the shorter side of the bot 31 visible FIG. 4, and a further two wheels 35 are provided on the opposite shorter side of the bot 31 (side and further two wheels 35 not visible in FIG. 4). The wheels 35 engage with tracks 17 and are rotatably mounted on the body 33 of the bot 31 to allow the bot 31 to move along the tracks 17. Analogously, two wheels 37 are provided on the longer side of the bot 31 visible in FIG. 4, and a further two wheels 37 are provided on the opposite longer side of the bot 31 (side and further two wheels 37 not visible in FIG. 4). The wheels 37 engage with tracks 19 and are rotatably mounted on the body 33 of the bot 31 to allow the bot 31 to move along the tracks 19.

The bot 31 also comprises container-lifting means 39 configured to raise and lower containers 9. The illustrated container-lifting means 39 comprises four tapes or reels 41 which are connected at their lower ends to a container-engaging assembly 43. The container-engaging assembly 43 comprises engaging means (which may, for example, be provided at the corners of the assembly 43, in the vicinity of the tapes 41) configured to engage with features of the containers 9. For instance, the containers 9 may be provided with one or more apertures in their upper sides with which the engaging means can engage. Alternatively or additionally, the engaging means may be configured to hook under the rims or lips of the containers 9, and/or to clamp or grasp the containers 9. The tapes 41 may be wound up or down to raise or lower the container-engaging assembly, as required. One or more motors or other means may be provided to effect or control the winding up or down of the tapes 41.

As can be seen in FIG. 5, the body 33 of the illustrated bot 31 has an upper portion 45 and a lower portion 47. The upper portion 45 is configured to house one or more operation components (not shown). The lower portion 47 is arranged beneath the upper portion 45. The lower portion 47 comprises a container-receiving space or cavity for accommodating at least part of a container 9 that has been raised by the container-lifting means 39. The container-receiving space is sized such that enough of a container 9 can fit inside the cavity to enable the bot 31 to move across the track structure 13 on top of storage structure 1 without the underside of the container 9 catching on the track structure 13 or another part of the storage structure 1. When the bot 31 has reached its intended destination, the container-lifting means 39 controls the tapes 41 to lower the container-gripping assembly 43 and the corresponding container 9 out of the cavity in the lower portion 47 and into the intended position. The intended position may be a stack 11 of containers 9 or an egress point of the storage structure 1 (or an ingress point of the storage structure 1 if the bot 31 has moved to collect a container 9 for storage in the storage structure 1). Although in the illustrated example the upper and lower portions 45, 47 are separated by a physical divider, in other embodiments, the upper and lower portions 45, 47 may not be physically divided by a specific component or part of the body 33 of the bot 31.

In some embodiments, the container-receiving space of the bot 31 may not be within the body 33 of the bot 31. For example, in some embodiments, the container-receiving space may be adjacent to the body 33 of the bot 31, e.g. in a cantilever arrangement with the weight of the body 33 of the bot 31 counterbalancing the weight of the container to be lifted. In such embodiments, a frame or arms of the container-lifting means 39 may protrude horizontally from the body 33 of the bot 31, and the tapes/reels 41 may be arranged at respective locations on the protruding frame/arms and configured to be raised and lowered from those locations to raise and lower a container into the container-receiving space adjacent to the body 33. The height at which the frame/arms is/are mounted on and protrude(s) from the body 33 of the bot 31 may be chosen to provide a desired effect. For example, it may be preferable for the frame/arms to protrude at a high level on the body 33 of the bot 31 to allow a larger container (or a plurality of containers) to be raised into the container-receiving space beneath the frame/arms. Alternatively, the frame/arms may be arranged to protrude lower down the body 33 (but still high enough to accommodate at least one container between the frame/arms and the track structure 13) to keep the centre of mass of the bot 31 lower when the bot 31 is loaded with a container.

To enable the bot 31 to move on the different wheels 35, 37 in the first and second directions, the bot 31 includes a wheel-positioning mechanism for selectively engaging either the first set of wheels 35 with the first set of tracks 17 or the second set of wheels 37 with the second set of tracks 19. The wheel-positioning mechanism is configured to raise and lower the first set of wheels 35 and/or the second set of wheels 37 relative to the body 33, thereby enabling the load-handling device 31 to selectively move in either the first direction or the second direction across the tracks 17, 19 of the storage structure 1.

The wheel-positioning mechanism may include one or more linear actuators, rotary components or other means for raising and lowering at least one set of wheels 35, 37 relative to the body 33 of the bot 31 to bring the at least one set of wheels 35, 37 out of and into contact with the tracks 17, 19. In some examples, only one set of wheels is configured to be raised and lowered, and the act of lowering the one set of wheels may effectively lift the other set of wheels clear of the corresponding tracks while the act of raising the one set of wheels may effectively lower the other set of wheels into contact with the corresponding tracks. In other examples, both sets of wheels may be raised and lowered, advantageously meaning that the body 33 of the bot 31 stays substantially at the same height and therefore the weight of the body 33 and the components mounted thereon does not need to be lifted and lowered by The system described with reference to FIGS. 1 to 4 has many advantages and is suitable for a wide range of storage and retrieval operations. In particular, it allows very dense storage of product, and it provides a very economical way of storing a huge range of different items in the containers 9, while allowing reasonably economical access to all of the containers when required for picking.

As shown in FIG. 3, a plurality of identical load handling devices 31 are provided, so that each load handling device 31 can operate simultaneously to increase the throughput of the system. The system illustrated in FIG. 3 may include specific locations, known as ports, at which containers can be transferred into or out of the system. An additional conveyor system (not shown) is associated with each port, so that containers transported to a port by a load handling device 31 can be transferred to another location by the conveyor system, for example to a picking station (not shown). Similarly, containers can be moved by the conveyor system to a port from an external location, for example to a container-filling station (not shown), and transported to a stack 12 by the load handling devices 30 to replenish the stock in the system.

Each load handling device 31 can lift and move one containers at a time. If it is necessary to retrieve a container (“target container”) that is not located on the top of a stack, then the overlying containers (“non-target containers”) must first be moved to allow access to the target containers. This is achieved in an operation referred to hereafter as “digging”. During a digging operation, one of the load handling devices sequentially lifts each non-target container from the stack containing the target container and places it in a vacant position within another stack. The target container can then be accessed by the load handling device and moved to a port for further transportation.

Each of the load handling devices is under the control of a central computer. Each individual container in the system is tracked, so that the appropriate containers can be retrieved, transported and replaced as necessary. For example, during a digging operation, the locations of each of the non-target containers is logged, so that the non-target containers can be tracked.

The system described with reference to FIGS. 1 to 5 has many advantages and is suitable for a wide range of storage and retrieval operations. In particular, it allows very dense storage of product, and it provides a very economical way of storing a huge range of different items in the containers, while allowing reasonably economical access to all of the containers when required for picking.

WO 2016/198565 discloses an automated storage and retrieval system in which a robotic picking arm is arranged to pick items from containers received in the grid of the storage and retrieval system. The applicant's co-pending application PCT/EP2022/069511 discloses further improvements relating to on-grid robotic picking.

### SUMMARY

In general terms, the disclosure introduces a robotic picking station which can be operated on a mezzanine level within a grid-based automated storage and retrieval system.

According to a first aspect of the present disclosure there is provided a storage system comprising: a first set of tracks extending in a first direction; a second set of tracks extending in a second direction transverse to the first direction, to form a grid comprising a plurality of grid cells, a framework structure on which the first set of tracks and the second set of tracks are received such that a stack of containers may be stored below the plurality of grid cells; a plurality of load-handling devices for lifting and moving containers stacked in stacks within the storage system, each of the load-handling devices being configured to move on the tracks above the stacks of containers at the top level of the grid; a mezzanine level formed within the storage system such that it is underneath the top level of the grid; and a robotic arm received on the mezzanine level such that it is underneath the top level of the grid and arranged, in use, to select an item from a first container received at the mezzanine level and to transfer the item to a second container received at the mezzanine level

By removing the picking arm from the surface of the grid, it is possible to retain many of the advantages of locating the picking arm on the grid without the disadvantage of losing grid spaces caused by the location of the picking arm on the grid. For example, by removing the picking arm from the grid it is no longer necessary to co-ordinate the movement of the picking arm with the movement of bots in grid cells adjacent to the picking arm.

By locating the mezzanine level directly below the top level of the grid, the time required to transfer a container from the grid level to a picking location (that is, a location from which the picking arm is able to access the contents of the container) is decreased. This increases the operational efficiency of the picking system.

The mezzanine may be at least two levels below the top level of the grid. Such an arrangement provides sufficient space for the picking arm to operate underneath the top level of the grid and decreases the time taken to transfer a container from the grid level to the mezzanine level.

A load-handling device may lower a container from the top level of the grid to the mezzanine level. A load-handling device may lift a container from the mezzanine level to the top level of the grid.

The mezzanine level may comprise eight zones surrounding the robotic arm. The eight zones may be divided into a first region and a second region wherein the first region and the second region each comprise one or more zones for receiving a delivery container and one or more zones for receiving a storage container. In particular, the eight zones may be divided into a first region and a second region wherein the first region and the second region each comprise one zone for receiving a delivery container and three zones for receiving a storage container.

According to a second aspect of the present disclosure there is provided a method of operating a storage system comprising: a first set of tracks extending in a first direction; a second set of tracks extending in a second direction transverse to the first direction, to form a grid comprising a plurality of grid cells, a framework structure on which the first set of tracks and the second set of tracks are received such that a stack of containers may be stored below the plurality of grid cells; a plurality of load-handling devices for lifting and moving containers stacked in stacks within the storage system, each of the load-handling devices being configured to move on the tracks above the stacks of containers at the top level of the grid; a mezzanine level formed within the storage system such that it is underneath the top level of the grid, the method comprising the steps of: i) selecting an item from a first container locating on the mezzanine level; and ii) transferring the item to a second container located on the mezzanine level. According to a further aspect of the present disclosure there is provided a computer-readable medium comprising computer-executable code for performing the method as described above.

### BRIEF DESCRIPTION OF THE DRAWINGS

Embodiments of the disclosure will now be described by way of example only with reference to the accompanying drawings, in which like reference numbers designate the same or corresponding parts, and in which:

FIG. 1 shows a schematic depiction of an automated storage and retrieval structure;

FIG. 2 shows a schematic depiction of s plan view of a section of track structure forming part of the storage structure of FIG. 1;

FIG. 3 shows a schematic depiction of a plurality of load-handling devices moving on top of the storage structure of FIG. 1;

FIGS. 4 and 5 show a schematic depiction of a load handling device interacting with a container;

FIG. 6a shows a schematic depiction of a storage system according to the present disclosure;

FIG. 6b shows a schematic depiction of a robotic arm suitable for use in the system of FIG. 6a;

FIG. 7 shows a schematic depiction of a top view of a part of the storage system of FIG. 6a;

FIG. 8 shows a schematic depiction of a top view of an alternative arrangement for a part of the storage system of FIG. 6a;

FIG. 9 shows an alternative arrangement of a storage system according to the present disclosure;

FIG. 10 shows a schematic depiction of a further example of a storage system according to the present disclosure; and

FIG. 11 shows a schematic depiction of a computer device.

### DETAILED DESCRIPTION OF EMBODIMENTS

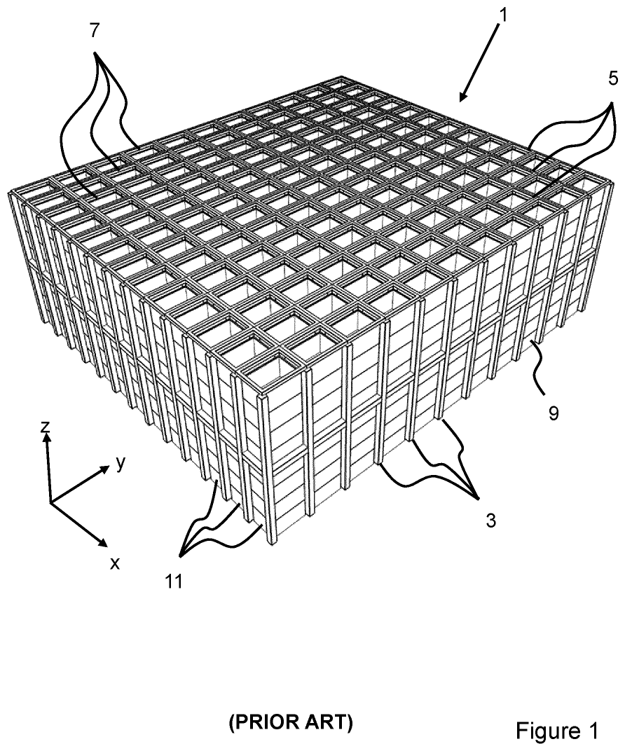

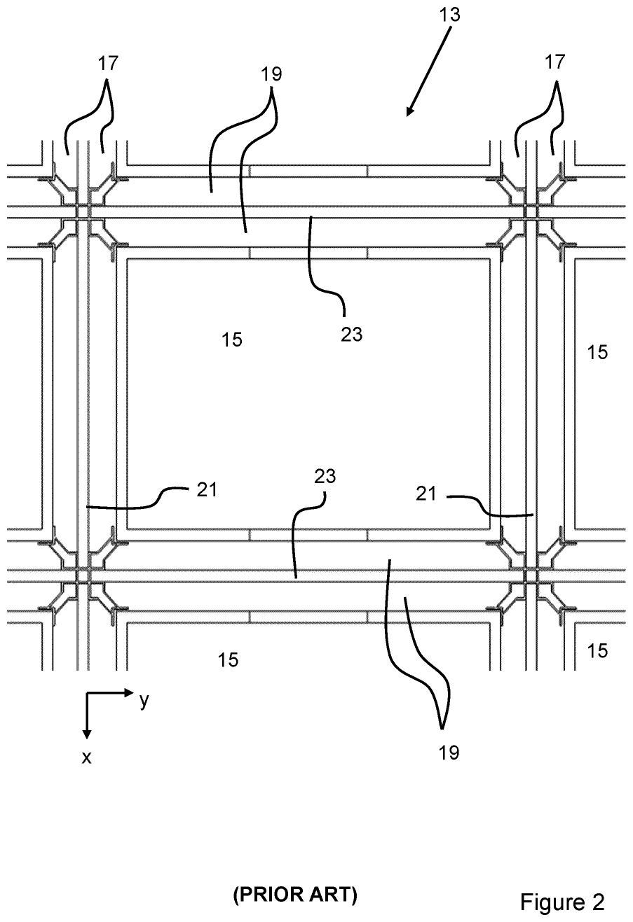

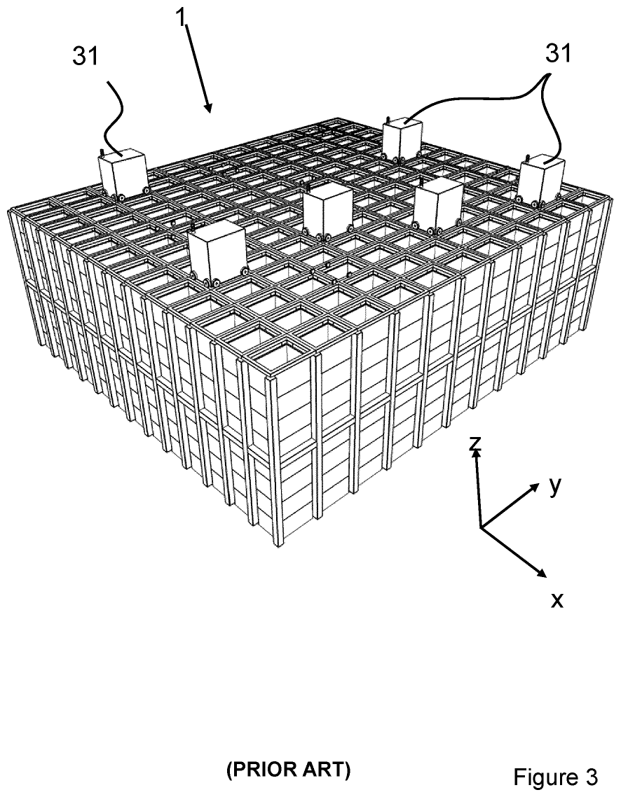

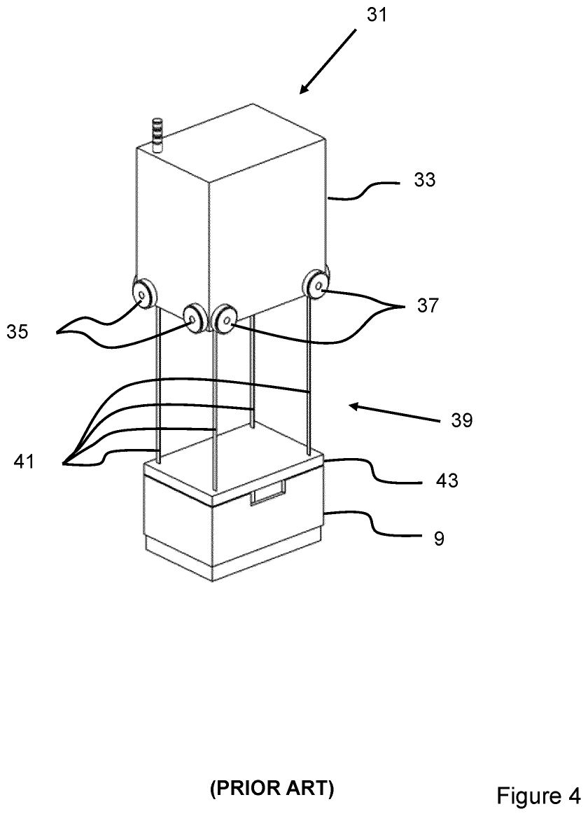

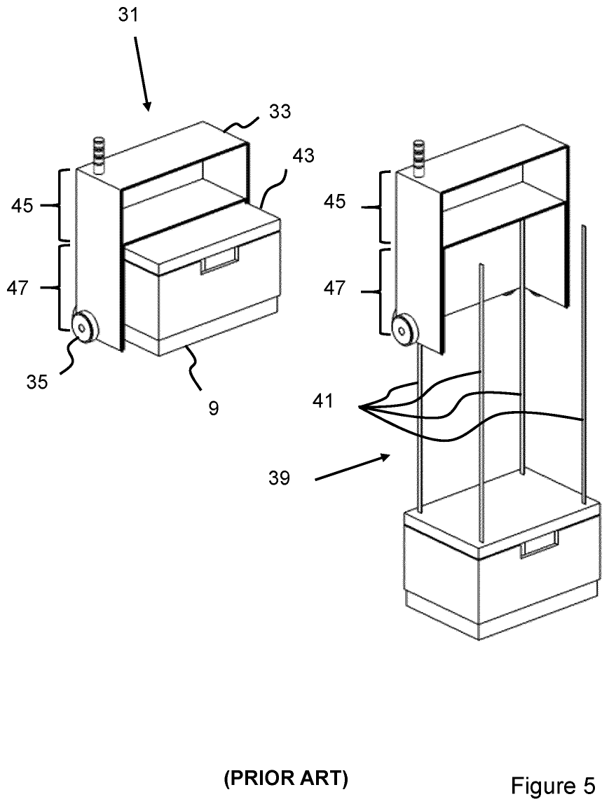

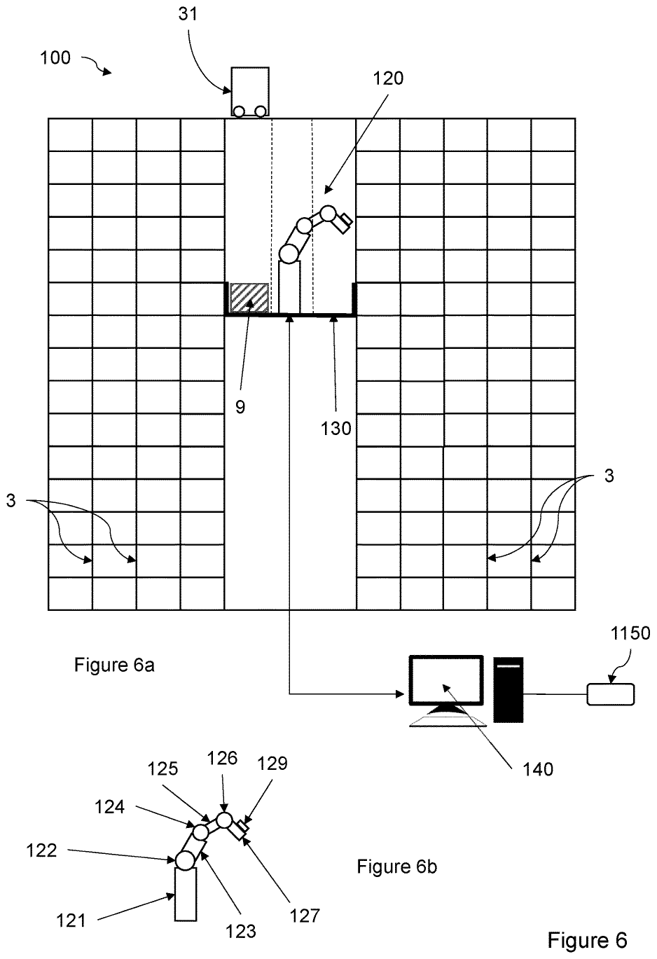

FIG. 6a shows a schematic depiction of a storage system 100 according to the present disclosure. The storage system 100 has many common features with the known storage system discussed above with reference to FIGS. 1-5. The storage system additionally comprises a mezzanine level 130 which occupies a region of the storage system and which is received below the top level of the storage system (the top level of the storage system being the level of the storage system on which the bots 31 operate). The storage system further comprises a robotic arm 120 which is mounted on the mezzanine level 130.

FIG. 6b shows a schematic depiction of a robotic arm suitable for use in the system shown in FIG. 6a. The robotic arm 120 comprises a base 121, first joint 122, upper arm portion 123, second joint 124, lower arm portion 125, third joint 126 and end effector 127. The base 121 extends substantially perpendicularly from the mezzanine level and is connected to the upper arm portion by the first joint, or shoulder. The upper arm portion is connected to the lower arm portion by the second joint, or elbow. The lower arm portion is connected to the end effector by the third joint, or wrist. The first joint, the second joint and the third joint may be selectively actuated such that the end effector may be moved along one or more of the x-axis, the y-axis and the z-axis. The robotic arm further comprises a camera 129 mounted on the robotic arm. The camera may be mounted at, or near to, the end effector 127. Alternatively, or in addition, a camera may be mounted on or near the wrist. and/or on or near to the elbow of the robotic arm. The robotic arm is configured to operate such that it can access the interior of a container 9 which is placed on the mezzanine level. FIG. 6a shows that the robotic arm is mounted on the mezzanine level. In an alternative configuration, the robotic arm may be mounted to the mezzanine level such that it extends through the mezzanine level.

The storage system may further comprise a computer device 140, which may be used to control the movement of the robotic arm and the activation of the end effector. Images from the camera may be fed to the computer device for processing to assist in the identification and/or grasping of items stored in containers. The computer device may be integrated within the robotic arm.

The robotic arm may, as shown in FIG. 6a, be connected to a remote computer device 140, for example by a wired Ethernet connection (or other network connection). The connection to the computer device and the connection to a source of electrical power may be made through the mezzanine level. Such a remote computer device may be used to control a plurality of robotic arms. The remote computer device may be the central computer used to control the load handling devices. In a further alternative, a cloud computing platform may be used to control the picking stations within the storage system. Whilst it is possible for the robotic pick station to automatically pick items from a storage container and then transfer them to delivery container where, for example, the product may be packed into a bag held within the delivery container, there may be conditions under which the robotic arm is not able to grasp a product item effectively, for example because of the orientation of the item in the storage container relative to other product items. In such a case, a repeated failure to grasp an item may cause an alert to be raised such that an operator may remotely operate the robotic arm, overriding the automatic operation of the robotic arm.

A controller apparatus 1150 may be communicably connected to the computer device 140 such that control commands may be transmitted to the robotic arm, causing the robotic arm to respond accordingly. The controller apparatus 1150 may comprise the keyboard 1115 and mouse 1112 of the computer device 140. Alternatively, or in addition, the controller apparatus 1150 may comprise modified gaming controllers (or similar handheld devices) and/or virtual reality or augmented reality headsets or other devices or interfaces.

The teleoperation of the robotic arm may comprise the operator taking complete control of the robotic arm, such that the components of the robotic arm are rotated or moved so as to bring the end effector into an appropriate position relative to the product to be picked. Subsequently the end effector can be activated to grasp the product, which can then be transferred to a delivery container (or a bag or carton within a delivery container). In an alternative, the operator may use the controller apparatus to define a region of an item to be picked, for example a flat surface of a box when the end effector comprises a suction end effector. The defined region can then be used by the robotic picking arm as an input into an automatic picking attempt. If the automatic picking attempt is still not successful then the operator may fully operate the arm to pick the item, as described above. It should be understood that some form of machine learning technology may be used to enable the automatic operation of the robotic picking arm. In such a case, the data generated during teleoperation of the robotic arm by a remote operator may be used to refine the algorithms used in the automatic operation of the robotic picking arm.

A robotic arm may comprise more than one different type of end effector. The central computer may send instructions to the robotic arm as to which end effector to use for each different SKU. Alternatively, the robotic arm may determine which end effector to use based on the weight, size, shape etc. of a product. Previous successes and/or failures to grasp and move an item may be used to update the selection of an end effector for a particular SKU. This information may be fed back to the central computer so that the success/failure information can be shared between different picking stations. A robotic arm may be able to change end effectors. For example, the robotic arm may comprise a storage area which can receive one or more end effectors. Optionally, the storage area may be located within the base 121 of the robotic arm. The robotic arm may be configured such that an end effector in use can be removed from the robotic arm and placed into the end effector storage area. A further end effector may then be removably attached to the robotic arm such that it can be used for subsequent picking operations. The end effector may be selected in accordance with planned picking operations.

The robotic arm may further comprise an optical sensor, which may be located on the base 121 of the robotic arm. The optical sensor may be used in the identification of products in the picking process. The picking station may comprise a plurality of optical sensors. The or each optical scanner may comprise a barcode reader. In an alternative arrangement, one or more barcode scanners may be installed on the robotic arm, such that the barcode scanner(s) move with the arm.

In use, a bot 31 may lower a container from the top level of the grid down to the mezzanine level. The container may be either a delivery container or a storage container. A storage container is a container which remains within the storage system and holds caches of products which can be transferred from the storage container to a delivery container. A delivery container is a container that is introduced into the storage system when empty and that has a number of different products loaded into it. Once the delivery container is full, for example the products loaded into the delivery container meet a volume limit, a weight limit or some other limitation, or all of a set of specified products have been loaded into the storage container, then the delivery container will be transferred from the storage system such that it can be loaded into a vehicle for delivery to a customer. A delivery container may comprise one or more bags or cartons into which products may be loaded. A delivery container may be substantially the same size as a storage container. Alternatively, a delivery container may be slightly smaller than a storage container such that a delivery container may be nested within a storage container.

In one example, one or more delivery containers and one or more storage containers may be lowered to the mezzanine level. The robotic arm then transfers selected caches of products from one of the storage container(s) to one of the delivery container(s). Once a storage container is no longer required then it may be retrieved by a bot and may then be replaced with a further storage container which stores further product(s). Once a delivery container is full then it can be retrieved to be loaded into a delivery vehicle (or to be stored elsewhere in the storage system prior to being loaded into a delivery vehicle). A further delivery container may then be lowered to the mezzanine level to be used to receive further caches of products.

The mezzanine level may be formed within the storage system such that it is not possible to store containers below it. For example, blanking plates may be fitted to the horizontal members 5, 7 of the storage grid to define the mezzanine level. Alternatively, a void may be created by removing a plurality of upright members 3 and horizontal members 5, 7 from the storage grid and then inserting a tray which defines the mezzanine level. The tray may comprise substantially vertical portions 132 which can be affixed to adjacent upright members 3 and horizontal members 5, 7 of the storage grid. It will be understood that other forms of support may be provided to the mezzanine level to maintain the physical integrity of the grid. The void below the mezzanine level may be used to house other equipment which is required for the operation of a fulfilment centre. Furthermore, the space underneath the grid structure above the mezzanine may be utilised for the mounting of cameras, barcode scanners, lights, etc.

The mezzanine level is received at least two levels below the top level of the storage grid, that is at least two levels below the level on which the bots move. It is believed that this is the minimum height which would allow a robotic arm to be installed beneath the top level and be able to pick from a container which is received on the mezzanine level. It should be understood that the mezzanine level may be located at a greater depth below the top level, for example to accommodate a taller robotic arm or for some other reason. It will be appreciated that the deeper the level of the mezzanine level, the greater the time that will be required to lower a container to the mezzanine level (and also to raise a container from the mezzanine level to the top level of the grid).

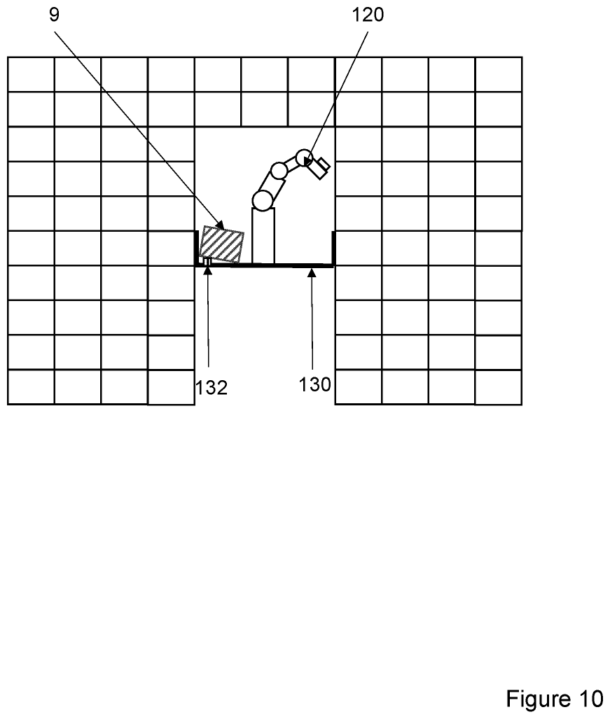

It will be understood that some of the upright members 3 and horizontal members 5, 7 will need to be removed from the space above the mezzanine level in order to allow the robotic arm to move freely enough to transfer product caches from container to container. In one alternative, the upright members 3 and horizontal members 5, 7 may be retained for one or more layers beneath the top level of the grid, with free space beneath these layers within which the containers can be received and the robotic arm can operate. For example, FIG. 10 shows an arrangement in which the upright members and horizontal members forming two layers of the grid are retained and there is then space provided within which the robotic arm can operate. In this example, the mezzanine level is 6 levels below the top level of the grid. It will be understood that such an arrangement is merely exemplary and that the number of retained levels of grid and the depth of the space for the robotic arm may be varied.

A bot may autonomously determine its own route across the grid to the location of the assigned storage container or a route may be determined and then transmitted to the bot. The route may be determined by the central computer. A method by which a bot may determine its route across the grid is disclosed in the applicant's co-pending application WO 2017/186825. A method by which communications to and from a bot may be performed is disclosed in the applicant's co-pending application WO2015/185726. It will be understood that the movement of the robotic arm whilst transferring product caches from a first container to a second container may be synchronised with the lowering of containers to the mezzanine level (and also the raising of containers from the mezzanine level, such that the movement of the robotic arm is not interfered with.

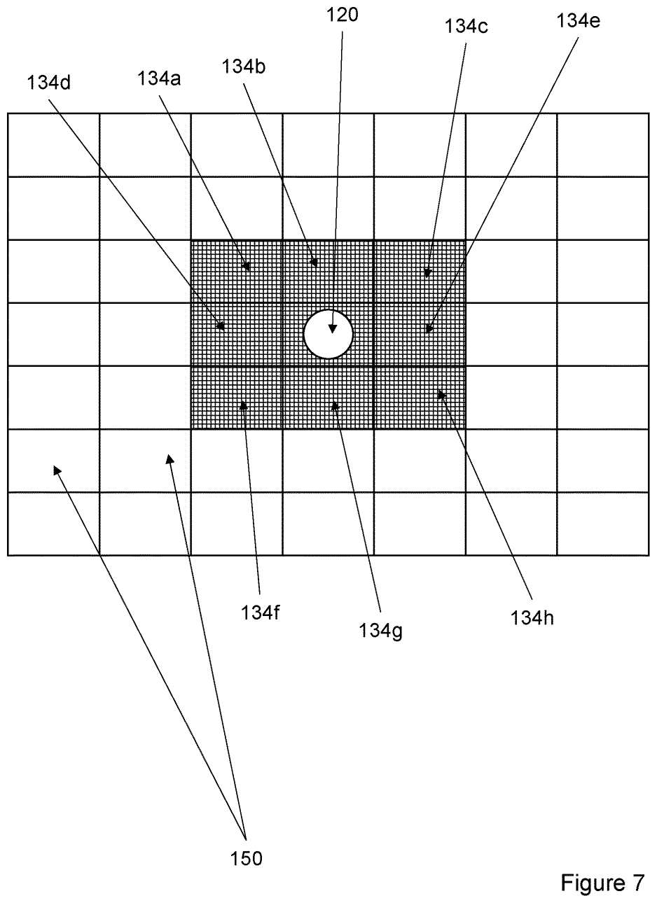

FIG. 7 shows a schematic depiction of a top view of a part of the storage system shown above in FIG. 6a, which shows the region of the mezzanine level 130 within the storage system 100. In this example, the mezzanine level extends across a region which comprises 3×3 grid cells. In this case, the robotic arm 120 is received in the centre of the mezzanine level such that it is able to reach into each of the adjacent picking zones 134 in the mezzanine level. The mezzanine level is received within a plurality of grid cells 150 which are available to receive containers.

In operation, a first bot may lower a first delivery container into zone 134b. This enables further bots to lower storage containers into picking zones 134a and 134c. For example, as the robotic arm is transferring a product each from a first storage container in picking zone 134a into the delivery container, one bot may be retrieving a second storage container from picking zone 134c such that a further bot can subsequently lower a third storage container into picking zone 134c. Once the picking from the first storage container is complete then the robotic arm may pick one or more items from the third storage container received in picking zone 134c. Whilst the robotic arm is picking product each(es) from the third storage container then a bot may retrieve the first storage container from picking zone 134a such that a yet further bot may lower a fourth storage container into picking zone 134a.

In a further example, delivery containers may be lowered into picking zones 134b and 134d. Picking zones 134a & 134g may be used for storage containers that are to be used when picking into the delivery container held in picking zone 134b. Picking zones 134e & 134f may be used for storage containers that are to be used when picking into the delivery container held in picking zone 134d. Picking zone 134c may be used for storage containers that can be used when picking into either the delivery container held in picking zone 134b or the delivery container held in picking zone 134d. It can be seen that it is advantageous to control the location of the delivery containers and the storage containers such that a delivery container is adjacent to a storage container. This reduces the distance that a product each needs to be moved during the picking process, reducing the time required to pick each product each.

It should be understood that this arrangement of picking zones is exemplary and that the use of the picking zones may be reconfigured dynamically with time. For example, it may be beneficial to change from the arrangement described above to a further arrangement in which 4 picking zones are allocated to storage containers with the other 4 picking zones being allocated to delivery containers.

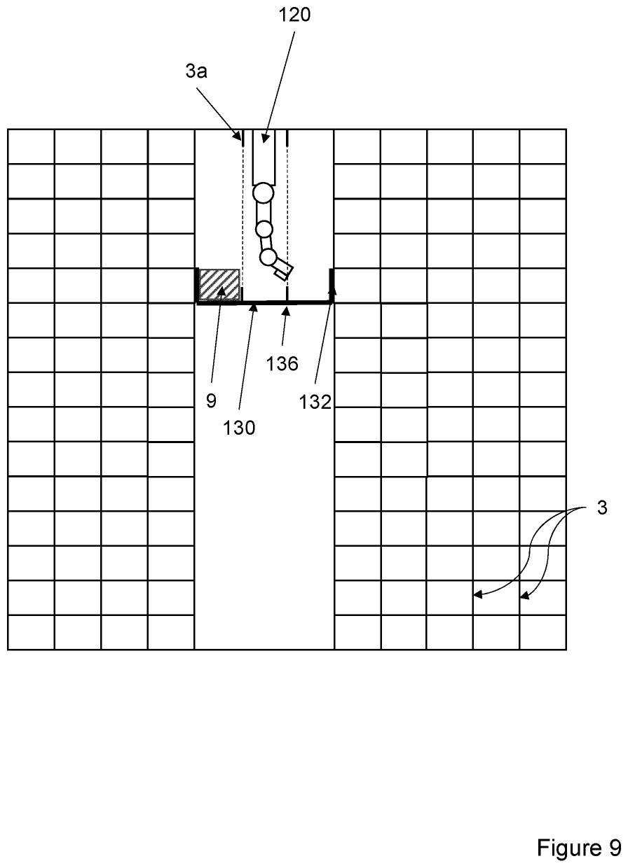

The mezzanine level may comprise projections 136 (see FIG. 9) which serve to define the picking zones. The projections may assist to guide the movement of a container into the correct location on the mezzanine level. Similarly, guides 3a may be formed on the underside of the grid to guide the containers as they are lowered by a bot (and also as containers are raised back up by a bot).

As an alternative to the use of bots to lower containers to the mezzanine level (and to also retrieve containers from the mezzanine level), some form or mechanical lift may be provided which can accept a container from a bot and then transport it down to the mezzanine level. The lift may then retrieve the container once the picking operation has been completed and return it such that it can be picked up by a bot.

It should be understood that a fulfilment centre or warehouse may require a large number of robotic arms in order to be able to pick the customer orders which need to be supplied. Thus, the storage system may comprise a number of mezzanine levels as shown in FIG. 7 dispersed throughout the storage system. Furthermore, the or each mezzanine level may comprise a plurality of robotic arms.

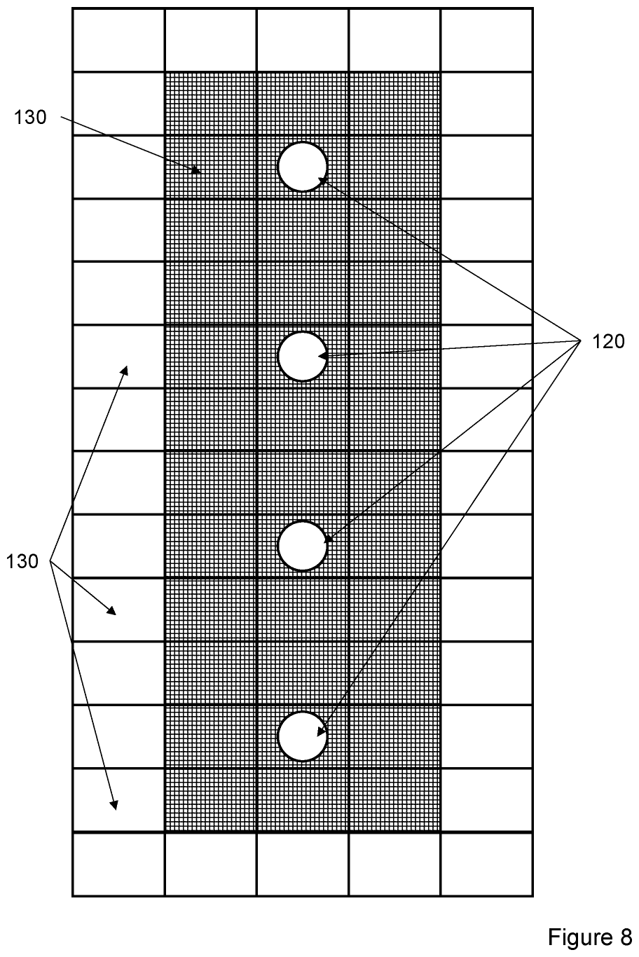

FIG. 8 shows a schematic depiction of such an alternative arrangement in which the mezzanine level comprises four robotic arms and the mezzanine level occupies a region of 12×3 grid cells. It should be understood that this arrangement is purely exemplary and that a mezzanine level region may have a greater or lesser number of robotic arms and/or the region of the mezzanine level region have a larger or smaller area and/or a different aspect ratio. If the robotic arm has a greater reach then it may be possible to cover a mezzanine level of a given size with fewer robotic arms.

FIG. 9 shows an alternative arrangement in which the robotic arm 120 is suspended from the storage grid above the mezzanine level. In this case, the robotic arm is shown as being suspended from the top level of the grid. It should be understood that the space above the mezzanine level may comprise one or more layers of the grid structures (that is the upright members 3 and horizontal members 5, 7) and that the robotic arm may be suspended from one or more of these members. The apparatus used to connect the robotic arm to the grid structure may include elements which reduce any mechanical vibration which could be transmitted to the robotic arm through the grid, which could be caused by the movement of the bots operating on the top level of the grid. For example, one or more upright members and/or one or more horizontal members may comprise shock absorbing elements.

FIG. 10 shows a schematic depiction of a further example of a storage system according to the present disclosure in which the mezzanine layer comprises a plurality of actuators 132, which can be selectively activated to lift a container such that the container is tilted towards the robotic arm. By inclining the container in this manner, it is easier for the camera of the robotic arm to view the internal space of the camera and should thus facilitate the efficient picking of product caches. It should be understood that each location into which a container may be lowered may comprise one or more of these actuators. The actuators will be in their retracted state when a container is being lowered onto or retrieved from the mezzanine level by a bot. One or more actuators may be activated prior to a picking operation and are then subsequently deactivated once the picking operation has been completed.

The region of the grid above the or each mezzanine level may be easily removable to allow access to the or each mezzanine for maintenance and repair. For example, the grid region(s) may be hinged or they may be retractable.

In a further alternative, the grid region above the mezzanine level may not be present, leaving a gap in the grid which is substantially the same size as the mezzanine level. In such a case, a cantilever bot may move to a grid cell adjacent to the gap and then lower a container down to the mezzanine level.

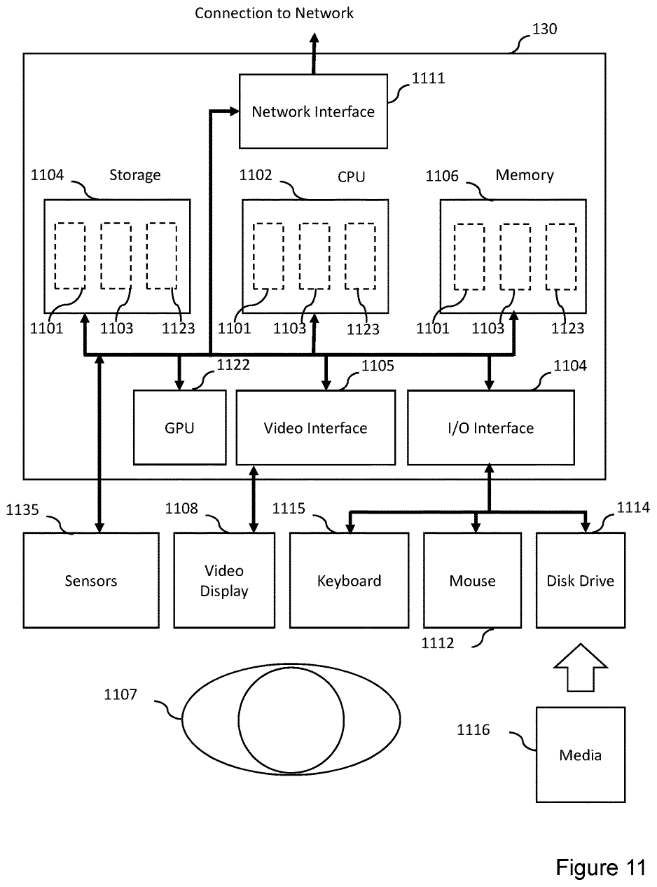

A suitably configured computer device 140, and associated communications networks, devices, software and firmware may provide a platform for enabling one or more embodiments as described above. By way of example, FIG. 11 shows a schematic depiction of a computer device 140 that may include a central processing unit (“CPU”) 1102 connected to a storage unit 1114 and to a random access memory 1106. The CPU 1102 may process an operating system 1101, application program 1103, and data 1123. The operating system 1101, application program 1103, and data 1123 may be stored in storage unit 1114 and loaded into memory 1106, as may be required. Computer device 140 may further include a graphics processing unit (GPU) 1122 which is operatively connected to CPU 1102 and to memory 1106 to offload intensive image processing calculations from CPU 1102 and run these calculations in parallel with CPU 1102. An operator 1107 may interact with the computer device 140 using a video display 1108 connected by a video interface 1105, and various input/output devices such as a keyboard 1115, mouse 1112, and disk drive or solid state drive 1114 connected by an I/O interface 1104. In a known manner, the mouse 1112 may be configured to control movement of a cursor in the video display 1108, and to operate various graphical user interface (GUI) controls appearing in the video display 1108 with a mouse button. The disk drive or solid state drive 1114 may be configured to accept computer readable media 1116. The computer device 140 may form part of a network via a network interface 1111, allowing the computer device 140 to communicate with other suitably configured data processing systems (not shown). One or more different types of sensors 1135 may be used to receive input from various sources.

The present system and method may be practiced on virtually any manner of computer device including a desktop computer, laptop computer, tablet computer or wireless handheld. The present system and method may also be implemented as a computer-readable/useable medium that includes computer program code to enable one or more computer devices to implement each of the various process steps in a method in accordance with the present disclosure. In case of more than computer devices performing the entire operation, the computer devices are networked to distribute the various steps of the operation. It is understood that the terms computer-readable medium or computer useable medium comprises one or more of any type of physical embodiment of the program code. In particular, the computer-readable/useable medium can comprise program code embodied on one or more portable storage articles of manufacture (e.g. an optical disc, a magnetic disk, a tape, etc.), on one or more data storage portions of a computing device, such as memory associated with a computer and/or a storage system.

In further aspects, the disclosure provides systems, devices, methods, and computer programming products, including non-transient machine-readable instruction sets, for use in implementing such methods and enabling the functionality described previously.

In this document, the language “movement in the n-direction” (and related wording), where n is one of x, y and z, is intended to mean movement substantially along or parallel to the n-axis, in either direction (i.e. towards the positive end of the n-axis or towards the negative end of the n-axis). In this document, the word “connect” and its derivatives are intended to include the possibilities of direct and indirection connection. For example, “x is connected to y” is intended to include the possibility that x is directly connected to y, with no intervening components, and the possibility that x is indirectly connected to y, with one or more intervening components. Where a direct connection is intended, the words “directly connected”, “direct connection” or similar will be used. Similarly, the word “support” and its derivatives are intended to include the possibilities of direct and indirect contact. For example, “x supports y” is intended to include the possibility that x directly supports and directly contacts y, with no intervening components, and the possibility that x indirectly supports y, with one or more intervening components contacting x and/or y. The word “mount” and its derivatives are intended to include the possibility of direct and indirect mounting. For example, “x is mounted on y” is intended to include the possibility that x is directly mounted on y, with no intervening components, and the possibility that x is indirectly mounted on y, with one or more intervening components. In this document, the word “comprise” and its derivatives are intended to have an inclusive rather than an exclusive meaning. For example, “x comprises y” is intended to include the possibilities that x includes one and only one y, multiple y's, or one or more y's and one or more other elements. Where an exclusive meaning is intended, the language “x is composed of y” will be used, meaning that x includes only y and nothing else. In this document, “controller” is intended to include any hardware which is suitable for controlling (e.g. providing instructions to) one or more other components. For example, a processor equipped with one or more memories and appropriate software to process data relating to a component or components and send appropriate instructions to the component(s) to enable the component(s) to perform its/their intended function(s).

In one respect, the present disclosure concerns a grid-based automated storage and retrieval system in which a mezzanine level is present under the top level grid. Containers may be lowered to and subsequently retrieved from the mezzanine level. A robotic arm is located such that it can access the interior of containers received on the mezzanine level and can transfer an item from a first container to a second container.

1. A storage system comprising:
a first set of tracks extending in a first direction;
a second set of tracks extending in a second direction transverse to the first direction, to form a grid comprising a plurality of grid cells,
a framework structure on which the first set of tracks and the second set of tracks are received such that a stack of containers may be stored below the plurality of grid cells;
a plurality of load-handling devices for lifting and moving containers stacked in stacks within the storage system, each of the load-handling devices being configured to move on the tracks above the stacks of containers at the top level of the grid;
a mezzanine level formed within the storage system such that it is underneath the top level of the grid; and
a robotic arm received on the mezzanine level such that it is underneath the top level of the grid and arranged, in use, to select an item from a first container received at the mezzanine level and to transfer the item to a second container received at the mezzanine level.

2. A storage system according to claim 1, wherein the mezzanine level is received within the framework structure of the storage system.

3. A storage system according to claim 1, wherein a load-handling device may lower a container from the top level of the grid to the mezzanine level.

4. A storage system according to claim 1, wherein a load-handling device may lift a container from the mezzanine level to the top level of the grid.

5. A storage system according to claim 1, wherein one or more cameras are mounted on the robotic arm.

6. A storage system according to claim 1, wherein the robotic arm comprises a computing device, the computing device comprising one or more processing units, one or more volatile data storage units, one or more non-volatile data storage units and a network interface.

7. A storage system according to claim 1, wherein the storage system is communicably coupled to a computing device, the computing device comprising one or more processing units, one or more volatile data storage units, one or more non-volatile data storage units and a network interface.

8. A method of operating a storage system comprising:
a first set of tracks extending in a first direction;
a second set of tracks extending in a second direction transverse to the first direction, to form a grid comprising a plurality of grid cells,
a framework structure on which the first set of tracks and the second set of tracks are received such that a stack of containers may be stored below the plurality of grid cells;
a plurality of load-handling devices for lifting and moving containers stacked in stacks within the storage system, each of the load-handling devices being configured to move on the tracks above the stacks of containers at the top level of the grid;
a mezzanine level formed within the storage system such that it is underneath the top level of the grid, the method comprising the steps of:
i) selecting an item from a first container locating on the mezzanine level; and
ii) transferring the item to a second container located on the mezzanine level.

9. A method according to claim 8, wherein the first container and the second container were lowered to the mezzanine level from the top level of the grid by a respective load-handling device prior to the execution of step i).

10. A method according to claim 8, wherein the first container and/or the second container are lifted from the mezzanine level to the top level of the grid by a respective load-handling device.

11. A method according to claim 10, wherein the one of the container(s) is moved by the respective load-handling device to a further grid location and is stored in one of the stacks of containers.

12. A method according to claim 10, wherein the one of the container(s) is moved by the respective load-handling device and then transferred from the storage system such that it can be subsequently loaded into a delivery vehicle.

13. A computer-readable medium comprising computer-executable code for performing the method according to claim 8.
